(19) United States
(12) Patent Application Publication
(10) Pub. No.: US 2019/0299157 A1
(43) Pub. Date: Oct. 3, 2019

(54) Method for the separation of a gas mixture and centrifuge for the separation of a gas mixture

(71) Applicant: BICARBO SP. Z O.O., Warszawa (PL)

(72) Inventors: Adam Krylowicz, Zamosc (PL); Jaroslaw Krylowicz, Warszawa (PL)

(21) Appl. No.: 16/307,379

(22) PCT Filed: Jun. 14, 2017
(86) PCT No.: PCT/IB2017/053527

§ 371 Date: Dec. 5, 2018

(30) Foreign Application Priority Data
Jun. 22, 2016 (PL) P.417687

(51) Int. Cl. B01D 53/24; H05H 1/48

(52) U.S. Cl. CPC B01D 53/24; H05H 1/48; B01D 2256/16; H05H 2001/486; B01D 2257/7025; B01D 2259/814; B01D 2259/818; B01D 2257/504

(57) ABSTRACT

The invention solves the problem of separation of a mixture of gases with varied molecular weights. According to the invention, the separation of a gas mixture consists in that a mixture of gases with varied molecular weights in fed into the inside of the device through slots in the inlet conduit, said slots disposed near capillary tubes having negative potential, whereas the outlet channels for the heavier molecular weight gases and those for the lower molecular weight gases are separated with a shutter with holes, said shutter being cyclically closed and opened for a period of time from 0.02 to 1.5 second. A centrifuge for the separation of gases has a cylindrical chamber, a capillary-and-blade electrode with negative potential located in the axis of the chamber and embedded on a conduit that feeds the gas mixture to the separator, an annular electrode being on the positive potential of the power source and grounded, located on the centrifuge perimeter, and is provided with two magnets, permanent or electromagnets. The electrode has capillary tubes connected to tubes and to the negative terminal of the power source. At the outlet of the electrode with the heavier gas holes is a first sliding shutter with holes and at the inlet of the light gas discharge pipeline is a baffle with holes and a second sliding shutter with holes, the first and the second shutter and being connected via a sliding mechanism to a controller.

The subject of the present invention is a method for the separation of a gas mixture and a centrifuge for the separation of gases of different densities using electric field, magnetic field and forces generated by these fields.

Known in the prior art is a method of spinning a gas alone in a static centrifuge using crossed electric and magnetic fields, especially a hot gas in the plasma state.

Known from the patent specification U.S. Pat. No. 5,039,312 is a method for the separation of components of a gas mixture being in the plasma state in a plasma arc, reaching angular speed at least 60000 revolutions per minute in a magnetic field whose force lines are perpendicular to the direction of the current flowing in the arc created between an internal spherical electrode and an outer cylindrical electrode formed into the shape of a nozzle. The plasma in the electric arc is brought up to a temperature of 1500 K to 10000 K, an approx. 600 A current flowing through said plasma at an arc welder generator voltage of 22 V.

The device disclosed in that patent, used to separate components of the gas mixture, has an internal spherical electrode and an outer cylindrical electrode with the shape of a nozzle, inside which are located outlets of gases to be separated. The light gas outlet is located at the axis of the cylindrical electrode and the higher specific density-gas outlet is located in or at the wall of the cylindrical electrode.

In another known patent specification U.S. Pat. No. 4,458,148 concerning a method and a device, gaseous substances are separated by centrifugal force using crossed electric and magnetic fields, the gas mixture being brought up to the plasma state using a CO₂ gas laser.

The present invention solves the problem of separation of a mixture of gases having different molecular weights by using crossed electric and magnetic fields and applying a control of the gas mixture centrifugation time. The method for the separation of gas mixtures of different molecular weights using an electrodynamic force causing a spinning movement of ions or charge-carriers in a cylindrical space by generating a radial electric field between a capillary-and-blade electrode located in the axis of a cylindrical chamber and an annular electrode located on the perimeter of the chamber and at the same time generating a magnetic field whose force lines are perpendicular to the lines of the electric field, according to the present invention, is characterised in that the mixture of gases having varied molecular composition in terms of densities is introduced to a closed cylindrical interior through slots in the inlet conduit, said slots arranged in the vicinity of capillary tubes connected to an electrode having negative voltage. The end of this conduit is built around with capillaries, forming a capillary-and-blade electrode which is brought to creation of either an ionic corona current within the gas or in a charge-carriers current in the form of charged drops of liquid or a discharge current in the plasma. That current, together with the magnetic field perpendicular to the direction of the radial current, causes the spinning of the gas mixture introduced into the chamber. By controlling the voltage, either a corona current or a discharge current in plasma is generated. The outlet channels in the course of the spinning of molecules or atoms, one for the gas of high molecular weight and the other for the gas of low molecular weight, cyclically open up for a time period of 0.02 to 0.2 second and close from 0.05 to 1.5 second.

Preferably, a low surface tension liquid is fed to the capillary tubes, in particular water containing surfactants that reduce surface tension.

Preferably, the electrodes are powered either by a direct current source with voltage lower than the critical corona voltage. The direct current source with rectangular voltage can be in particular a Tesla transformer or an arc welder power supply.

Preferably, the gas with the lower molecular weight, additionally purified for use for example in the food industry, is fed to a separate outlet channel through a membrane.

The gas, spinning in the centrifuge chamber with the light gas outlet closed and the heavy gas outlet periodically opened and closed, is accelerated to a pre-set outlet speed and only flows out into the heavy gas outlet.

The separation method according to the present invention allows a precise gas separation.

A special advantage of this method of separation of gases in a centrifuge is generation of an increase in the density of the corona current, especially in cold gases, by introducing to the gas negative charge-carriers in the form of negatively charged microdroplets through capillary tubes being at high negative potential, connected to the negative terminal of a power source.

### EXAMPLE I

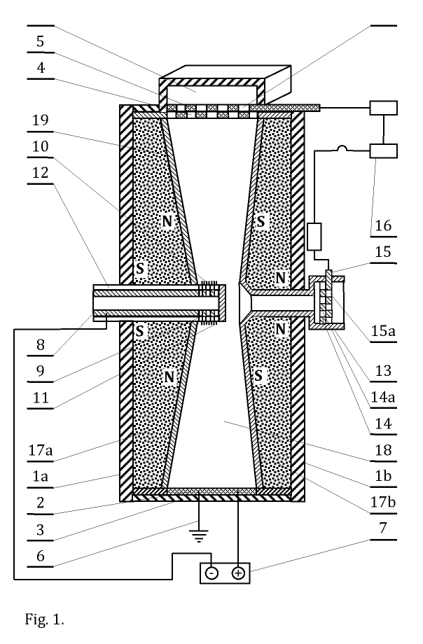

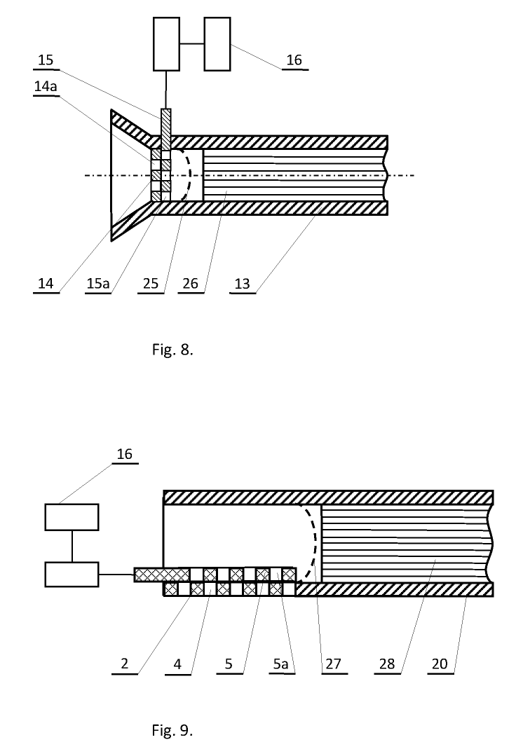

The example uses the schematic drawing of the centrifuge in FIG. 1, FIG. 8 and FIG. 9.

The cylindrical chamber of the gas centrifuge was fed through a conduit 8 with a gas mixture: a desulfurised and dust-cleaned raw gas containing 25% hydrogen, 68% methane 3% CO₂ and 4% residual gas. The gas mixture was introduced through slots 9 in a perforated end of the conduit 8, which is the capillary-and-blade electrode 10 fitted with capillary tubes 11 connected to it.

The capillary-and-blade electrode 10, located axially inside the chamber 18, was connected to the negative terminal of a DC power source 7. An annular electrode 2 in the form of a cylinder was grounded and connected to the positive terminal of the DC power source 7. A voltage of 3 kV which was applied to electrodes 2 and 10 caused the creation of a 1.88 A corona current with current density of 0.05 A/cm², in the form of negative ions of the gas ionised at the capillary tubes. Inside the centrifuge chamber 18 there were created simultaneously by a permanent magnet: a magnetic field with lines perpendicular to the lines of the electric field, whose induction was 0.5 T obtaining a force of 0.042 N, perpendicular to the direction of the corona current and to the direction of the magnetic field lines. At the outlet of the annular electrode 2, in a section accounting for about 15% its surface, holes 4 were made. After the gas flow was started, the outlet holes 4 in the electrode 2 to the exhaust channel 20 and holes 14a in a baffle 14 to the exhaust pipeline 13 were cyclically opened for a period of 0.08 second and closed for a period of 0.2 second.

In order to recover very pure hydrogen used in the food industry, a perpendicular palladium-silver membrane 25 made of a Pd80AG20 alloy was installed in the recovered light gas discharge pipeline 13, as shown on FIG. 8, said membrane easily permeable for hydrogen at a temperature of about 500° C., at a pressure of about 6 atm.

Similarly, in order to isolate pure CO₂ in the recovered heavy gas discharge channel 20, a membrane module 28 with plastic tube diaphragms was installed, as shown in FIG. 9, permeable for CO₂ at approximately 40° C. and at a pressure of about 6 atm.

After carrying out the separation of the gas mixture, a gas containing 99.99% hydrogen was obtained at the outlet. A mixture of the heavier gases recovered, containing methane CO₂ and residual gases, discharging through channel 20, is subjected to further separation in a subsequent centrifuge.

The separation process runs as follows.

The resultant force causes the spinning of the raw gas having a mass of m_{g}=0.2535 g at the time of the closure of the outlets by both spinning time mechanisms for gas spinning around the axis of the gas centrifuge, generating tangential acceleration of 167.2 m/s² perpendicular to the radius of the spinning gas layer. By its action, the resultant force generates a force impulse that causes a change in the momentum of the spinning gas layer, which increases the angular speed w of the spinning gas. The resulting centripetal force acting on particles of the spinning raw gas with different molecular weights separates the gas with the smallest molecular weight, i.e. hydrogen with density of 0.0823 kg/m³, from the remaining gas mixture having average density of 0.732 kg/m³. The hydrogen accumulates at the axis of the centrifuge and the remaining heavier gas flows to the annular electrode 2. Opening the holes 14a causes hydrogen to flow to the light gas discharge pipeline 13, and opening the holes 4 causes the remaining, mixture of heavier gases to flow through these holes 4 to the heavier gas discharge channel 20. Cyclic closing and opening of the holes at outlets causes more accurate separation of the gases.

### EXAMPLE II

The gas separation process is fed with the raw gas described in Example I but having a higher temperature. The centrifuge was provided with high temperature resistant ceramic disk insulators 19 having an insulating layer made of aerogel, to protect magnets 17a and 17b on the centrifuge chamber 18 side. Liquid cooling was applied for the magnets 17a and 17b, annular electrode 2 and electrode 10 with capillary tubes 11. The introduced gas mixture has a temperature of approximately 800° C. and critical corona voltage was about 337 V. The process of gas mixture separation was conducted using a welder power supply, exceeding the critical corona voltage, whereas welding power supply arc discharge voltage was 22 V, and discharge current was 12 A. Magnetic induction was 0.2 T. As a result of the separation process carried out, hydrogen with approximately 1% of impurities was obtained. The process conducted in such conditions ran on average around five times faster than the diaphragm-based gas separation process. After the critical corona voltage was exceeded, arcing occurred in the plasma at a temperature exceeding 1500° C. The force Fᵢₙ thus generated causes the plasma to spin. With gas outlet closing time of 0.2 s, angular speed of 68000 rpm was obtained for a spinning gas with a mass m_{g}=2.535×10⁻⁴ kg. This angular velocity is sufficient for selective separation of gases in plasma. The other operations of the gas distribution process were carried out like in Example I.

### EXAMPLE III.

The separation process in a gas centrifuge employs air to separate nitrogen from oxygen with contaminants, containing approximately 21% oxygen, 78% nitrogen and 1% contaminants (argon). A centrifuge of 6 dm³ in volume was used, in which dielectric capillary tubes were supplied with water having reduced surface tension. The flow rate of the pretreated water to the capillary tubes 11 was 1.2 cm³/s. The capillary tubes 11 were provided with pin wires 24 that were connected to the negative terminal of a DC source 7. A 1 kV voltage that was applied to electrodes 2 and 10 caused a corona current on charge carriers with an amperage of 10 A and current density of 0.05 A/cm². A solenoid with superconductor coils generated homogeneous magnetic field with field lines having magnetic induction of 5 T, perpendicular to the direction of the radial corona current. As a result of the separation performed, oxygen containing about 8% of contaminants, including 5% of argon, was obtained.

The air separation process proceeded out as follows.

A 10 A corona current flows from electrode 10 to electrode 2 on negative charge carriers in the form of negatively charged droplets. Critical corona voltage was 2.1 kV. Electrode 10 in the form of capillary tubes 11 with pin wires 24 produces microdrops with a diameter of approximately 1 μm and volume of 5.23×10⁻³ mm³ and a capacitance of 4.358×10⁻¹⁵ F, charged by blade electrodes having a potential of 1 kV with respect to electrode 2 grounded to a charge of 4.358×10⁻¹² C located on every droplet. These droplets, produced at a rate of 2.295×10¹² drops/sec, transfer a negative charge Q=10 C during a time period of t=1 sec. from electrode 10 to electrode 2, which corresponds to generating and transferring a corona current of approximately 10 A. Charged by electrical forces, the droplets break into smaller droplets down to as little as 33 Ādroplets containing single elementary charges.

The force F_{W} causes the spinning of air with a mass of 7.1 g along with charge carriers with a total microdroplets mass of 0.24 g, totaling approx 7.34 g, during outlets closing time of 0.2 s. The produced angular speed of the spinning air, approximately 65000 rpm, creates a centripetal force acting on the particles of the spinning air having different molecular weights. The centripetal force separates nitrogen having a density of 1.146 kg/m³ from the remaining gas mixture, i.e. from oxygen having density of 1.308 kg/m³ together with contaminants having a density of 1.7 kg/m³. Nitrogen accumulates at the axis and discharges to a discharge pipeline 13, while oxygen together with contaminants flows to the annular electrode 2 and next to a discharge channel 20.

The subject of the present invention is also a centrifuge for the separation of gas from the gas mixture—a gas centrifuge.

In accordance with the present invention, the centrifuge for the separation of gases has a cylindrical chamber, an electrode with negative potential located in the axis of the chamber, and a positive electrode located on the perimeter, provided with permanent magnets or electromagnets and having in the axis of the chamber a conduit to feed a gas mixture and two discharge channels, is characterised by the fact that at the outlet of the annular electrode there is a first slidable shutter and at the inlet of the light gas discharge pipeline there is a second slidable shutter, the first and the second shutter being connected by a sliding mechanism with a controller. The negative potential electrode, located at the end of the gas mixture feed conduit, is equipped with capillary tubes located radially on the perimeter of this electrode and connected to tubes located along the inlet conduit, which capillary tubes are connected to the negative terminal of a power source, and additionally, the gas conduit has slots disposed near the capillary tubes.

Preferably, in the outlet part of the annular electrode there are first holes and the first shutter has second holes positioned accordingly to the locations of the first holes in the annular electrode. At the inlet of the light gas discharge pipeline there is a baffle with third holes, and in the second shutter located at the said baffle there are fourth holes disposed in the same manner as the third holes in the baffle.

Preferably, pin wires are located in the capillary tubes, said wires connected to a DC source, whereas the tubes and the capillaries connected to these tubes are made of a dielectric material.

Preferably, a semi-permeable membrane is installed in the lower molecular weight gas discharge pipeline.

Preferably, the tubes are laid on strip electrodes disposed in groves in the gas feed conduit. The subject of the present invention is illustrated in an exemplary embodiment in a drawing where

FIG. 1 is a schematic diagram of the separation centrifuge in longitudinal cross-section,

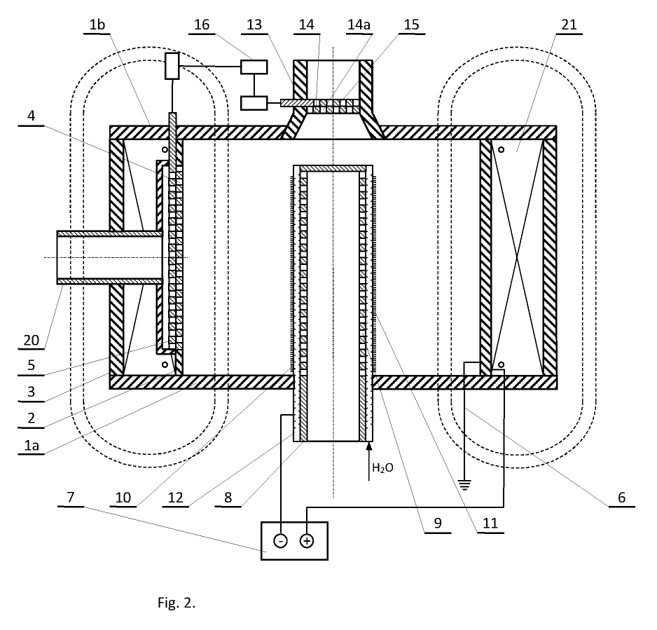

FIG. 2 is a schematic diagram of the variant of the centrifuge with a solenoid,

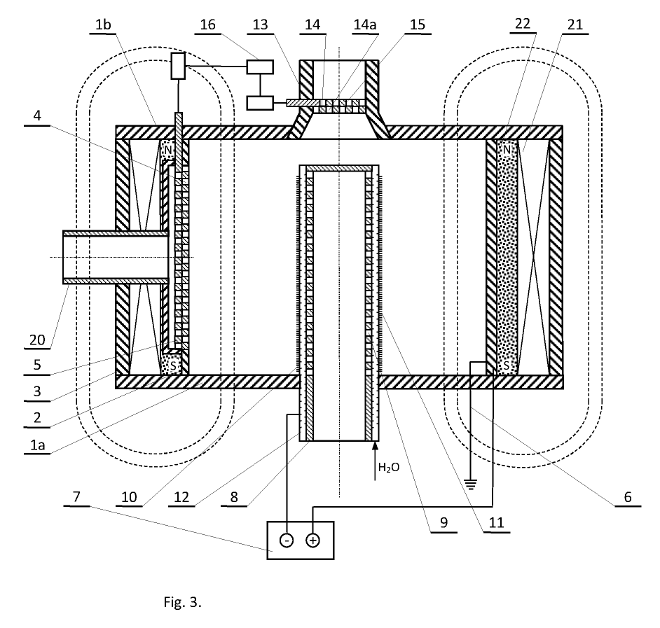

FIG. 3 is a schematic diagram of the device with a solenoid,

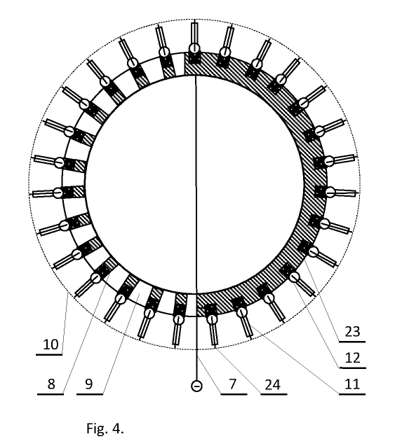

FIG. 4 is a cross-sectional view of a negative voltage electrode,

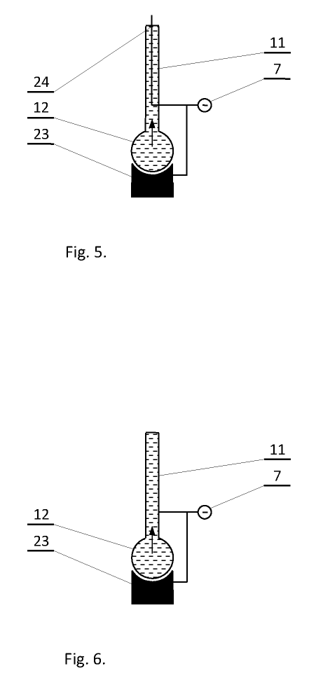

FIG. 5 depicts a design detail of a capillary tube made of a dielectric,

FIG. 6—a design detail of the capillary tube made of an electrically conducting material,

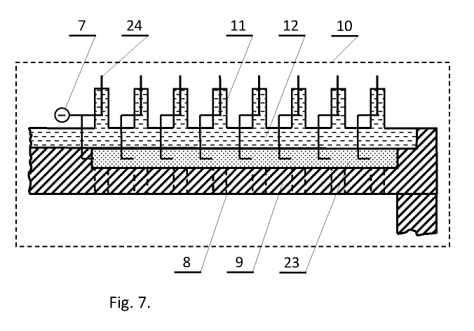

FIG. 7—a fragment of the capillary-and-blade electrode in longitudinal cross-sectional view,

FIG. 8—a part of the heavy gas discharge pipeline in longitudinal cross-sectional view, and

FIG. 9—a part of the heavy gas discharge channel in longitudinal cross-sectional view.

### EXEMPLARY DEVICE

As shown in FIG. 1, the gas centrifuge has two round plates 1a and 1b of the casing, between which there is an annular electrode 2 shielded with an insulating band 3, thus creating a centrifuge chamber 18. On a part of the annular electrode 2 there are first holes 4 and above them a perforated shutter 5 having second holes 5a, said shutter connected to a sliding mechanism and a controller 16. The second holes 5a are arranged correspondingly to the arrangement of the first holes 4. The annular electrode 2 is connected to the positive terminal of a power source 7, and also to the ground 6. In the axis of the round disc 1a of the casing there is a plugged conduit 8 that supplies a gas mixture to the centrifuge chamber 18 through slots 9. An end of the conduit 8 introduced into the chamber 18 is a capillary-and-blade electrode 10. On the end of the conduit 8 there are capillary tubes 11 set radially, connected to liquid feeding tubes 12 which are positioned around the perimeter, in parallel to the axis of the conduit 8, and in parallel to them there are strip electrodes 23 electrically connected to the negative terminal of the current source 7. In the axis of the second round plate 1b there is a light gas discharge pipeline 13, provided at the inlet with a baffle 14 having third holes 14a. At the baffle, there is a shutter 15 with fourth holes 15a, spaced apart correspondingly to the locations of the third holes 14a. The shutter 15 is connected through the sliding mechanism to a controller 16.

Located inside the chamber 18 are permanent disc magnets 17a and 17b. The surface of the magnets 17a and 17b is shielded from the side of the chamber 18 with an insulating coating 19. Above the first holes 4 in a part of the annular electrode 2 and above the shutter 15 there is a discharge channel 20 for the separated heavier gases.

As shown in FIG. 2 according to an embodiment of the invention, the annular electrode 2 is surrounded by a solenoid 21 to excite magnetic field. According to another embodiment shown in FIG. 3, the annular electrode is surrounded by a ferromagnetic core 22, around which there is the solenoid 21. The solenoid 21 and the electrode 2 form, together with the round plates 1a and 1b, the centrifuge chamber.

FIG. 4 shows a magnified cross section of the electrode 10 which is inside the centrifuge chamber 18. In grooves on the perimeter of the conduit 8, situated in parallel to the axis, there are strip electrodes 23 conducting the electric current, on which tubes 12 are laid. The strip electrodes 23 are connected to the negative terminal of the power source 7. Inside the capillaries 11, whose longitudinal cross section is shown in the drawing FIG. 5, made of a dielectric material, there are pin wires 24 whose tips project beyond the capillaries 11, said pin wires connected to the strip electrodes 23. Between the capillary tubes 11 there are slots 9.

In another embodiment, shown in the drawing FIG. 6, the capillary tubes 11 are made of an electrically conducting material and are connected to the negative terminal of the power source 7 through the strip electrodes 23. The capillary tubes 11 perform the function of a corona electrode.

FIG. 7 shows a longitudinal section of the capillary-and-blade electrode 10. Embedded in the grooves along the conduit 8 are strip electrodes 23 connected to the negative terminal of the power source 7. Placed on the strip electrodes 23 are tubes 12 that deliver a liquid to the capillary tubes 11 and are connected to these capillary tubes 11. Inside the capillary tubes 11 made of a dielectric material are pin wires 24 connected to the strip electrodes 23.

As shown in the drawing FIG. 8, the pipeline 13 for discharging light gases is additionally provided with a semi-permeable perpendicular membrane 25 and a separating module 26 with tube membranes. FIG. 9 shows a longitudinal cross section of the outlet channel 20 for the separated heavier gases, which is additionally equipped with a semi-permeable perpendicular membrane 27 and a separating module 28 with tube membranes.

### NUMERIC REFERENCES TO FIG. 1

1a—Casing plate of MGD centrifuge,

1b—Casing plate of MGD centrifuge,

2—Annular electrode,

3—Insulating band,

4—Holes in a part of annular electrode,

5—Perforated shutter of the heavy gas spinning time mechanism,

6—Grounding of annular electrode,

7—Power source,

8—Gas mixture feed conduit,

9—Slots in the feed conduit,

10—Capillary-and-blade electrode,

11—Blade capillaries,

12—Capillary tubes liquid conduit,

13—Light gas discharge pipeline,

14—Light gas pipeline baffle,

14a—Holes in the pipeline baffle,

15—Perforated shutter of the light gas spinning time mechanism,

16—Controller with a slide mechanism,

17A—Disc magnet or electromagnet,

17b—Disc Magnets or electromagnet,

18—MGD gas centrifuge chamber,

19—Magnet cover,

20—Discharge channel for separated heavier gases.

### NUMERIC REFERENCES TO FIG. 2

1a—Casing plate of MGD centrifuge,

1b—Casing plate of MGD centrifuge,

2—Annular electrode,

3—Insulating band,

4—Holes in a part of annular electrode,

5—Perforated shutter of the heavy gas spinning time mechanism,

6—Grounding of annular electrode,

7—Power source,

8—Gas mixture feed conduit,

9—Slots in the feed conduit,

10—Capillary-and-blade electrode,

11—Blade capillaries,

12—Capillary tubes liquid conduit,

13—Light gas discharge pipeline,

14—Light gas pipeline baffle,

14a—Holes in the pipeline baffle,

15—Perforated shutter of the light gas spinning time mechanism,

16—Controller with a slide mechanism,

20—Discharge channel for separated heavier gases,

21—Solenoid.

### NUMERIC REFERENCES TO FIG. 3

1a—Casing plate of MGD centrifuge,

1b—Casing plate of MGD centrifuge,

2—Annular electrode,

3—Insulating band,

4—Holes in a part of annular electrode,

5—Perforated shutter of the heavy gas spinning time mechanism,

6—Grounding of annular electrode,

7—Power source,

8—Gas mixture feed conduit,

9—Slots in the feed conduit,

10—Capillary-and-blade electrode,

11—Blade capillaries,

12—Capillary tubes liquid conduit,

13—Light gas discharge pipeline,

14—Light gas pipeline baffle,

14a—Holes in the pipeline baffle,

15—Perforated shutter of the light gas spinning time mechanism,

16—Controller with a slide mechanism,

20—Discharge channel for separated heavier gases,

21—Coil,

22—Annular ferromagnetic core.

### NUMERIC REFERENCES TO FIG. 4

7—Power source, negative electrode,

8—Gas mixture conduit (pipeline),

9—Slots in the conduit and in the capillary-and-blade electrode,

10—Capillary-and-blade electrode,

11—Capillary tubes,

12—Tubes for capillary liquid,

23—Strap electrodes,

24—Pin wire.

### NUMERIC REFERENCES TO FIG. 5

7—Power source, negative electrode,

11—Dielectric capillary tube,

12—Tube for capillary liquid,

23—Strap electrode,

24—Pin wire.

### NUMERIC REFERENCES TO FIG. 6

7—Power source, negative electrode,

11—Conductive capillary tube,

12—Tube for capillary liquid,

23—Strap electrode.

### NUMERIC REFERENCES TO FIG. 7.

7—Power source, negative electrode,

8—Slots (pipeline) for gas mixture,

9—Holes in the conduit and in the capillary-and-blade electrode,

10—Capillary-and-blade electrode,

11—Capillary tubes,

12—Tubes for capillary liquid,

23—Strap electrodes,

24—Pin wires.

### NUMERIC REFERENCES TO FIG. 8

13—Light gas discharge pipeline,

14—Light gas pipeline baffle,

14a—Holes in the pipeline baffle,

15—Perforated shutter of the light gas spinning time mechanism,

16—Controller with a slide mechanism,

25—Perpendicular diaphragm (membrane),

26—Separation module with tube membranes.

### NUMERIC REFERENCES TO FIG. 9.

2—Annular electrode ring, perforated part,

4—Holes in the annular electrode,

5—Perforated shutter of the heavy gas spinning time mechanism,

5a—Holes in the shutter,

16—Controller with a slide mechanism,

20—Heavier gas discharge channel,

27—Perpendicular diaphragm (membrane),

28—Separation module with tube membranes.

1. A method for the separation of a gas mixture of different molecular weights using an electrodynamic force causing a spinning movement of ions or charge-carriers in a cylindrical space by generating a radial electric field between a capillary-and-blade electrode located in the axis of a cylindrical chamber and an annular electrode located on the perimeter of the chamber and at the same time generating a magnetic field whose force lines are perpendicular to the lines of the electric field, characterized in that a mixture of gases having varied molecular weights is introduced into the centrifuge chamber through slots in the inlet conduit, said slots being located near capillary tubes connected to an electrode having negative voltage, and there is generated a corona current between that electrode and the positive annular electrode on the perimeter of the chamber, and that current together with the magnetic field causes a spinning of the gas mixture introduced into the chamber, whereas the outlet channels, one for the heavy molecular weight gas and the other for the light molecular weight gas are baffled with a shutter which opens cyclically for a time period of 0.02 to 0.2 second and closes for a time period from 0.05 to 1.5 second.

2. The method for the separation of gas mixtures according to claim 1, characterized in that the corona current between the negative voltage electrode and the positive annular electrode is an ionic corona current in the gas.

3. The method for the separation of gas mixtures according to claim 1, characterized in that the corona current between the negative voltage electrode and the positive annular electrode is a corona current of charge carriers in the form of charged droplets of a liquid.

4. The method for the separation of gas mixtures according to claim 1, characterized in that the corona current between the negative voltage electrode and the positive annular electrode is a discharge current in plasma.

5. The method for the separation of gas mixtures according to claim 1, characterized in that a low surface tension liquid is fed to the capillary tubes, preferably water containing surfactants that reduce the surface tension of the water.

6. The method for the separation of a gas mixture according to claim 2, characterized in that the electrodes are supplied by a direct current source whose voltage is lower than the critical corona voltage, including a direct current source of rectangular voltage, preferably using a Tesla transformer, or an arc welder power supply.

7. The method for the separation of a gas mixture according to claim 1, characterized in that the separated gas having lower molecular weight is directed to the outlet channel through a membrane.

8. The method for the separation of a gas mixture according to claim 1, characterized in that the gas spinning in the centrifuge chamber at the light gas outlet closed and the outlet at the annular electrode periodically opened and closed is accelerated to a pre-set outlet speed and flows out to the heavier gases outlet channel.

9. A centrifuge for the separation of gases, a magnetodynamic centrifuge, having a cylindrical chamber, an electrode with negative potential located in the axis of the chamber and a positive electrode located on the perimeter, provided with permanent magnets or electromagnets or a solenoid, having in the axis of the chamber an inlet conduit to feed a gas mixture and two outlet channels, characterized in that at the outlet being part of the heavier gas annular electrode there is a first sliding shutter, and at the inlet of the light gas discharge pipeline there is a second sliding shutter, said first and second sliding shutter and being connected via a sliding mechanism to a controller, and in addition, the negative potential electrode located at the end of the conduit is provided with capillary tubes arranged radially on the perimeter of the electrode and connected to tubes located along the conduit, said capillary tubes being connected to the negative terminal of a power source, further, the gas feed conduit has slots located near the capillary tubes.

10. The gas separation device according to claim 9, characterized in that in the outlet part of the annular electrode there are first holes, and the first sliding shutter has second holes located correspondingly to the locations of the first holes, while at the inlet of the pipeline there is a baffle with third holes and in the second shutter there are fourth holes arranged correspondingly to the third holes.

11. The gas separation device according to claim 9, characterized in that in the capillary tubes there are disposed pin wires connected to a DC power source, said capillary tubes being made of a dielectric material.

12. The gas separation device according to claim 9, characterized in that in the lower molecular weight gas outlet channel there is installed a perpendicular semi-permeable membrane or a separating module with tube membranes.

13. The gas separation device according to claim 6, characterized in that the tubes that supply the liquid to the capillary tubes are laid on the strip electrodes located in grooves made in the conduit.

14. The gas separation device according to claim 11, characterized in that the pin wires are connected to the strip electrodes.

15. The gas separation device according to claim 9, characterized in that the capillary tubes made of an electrically conductive material are connected to the strip electrodes.
